(19) United States
(12) Patent Application Publication
(10) Pub. No.: US 2021/0264809 A1
(43) Pub. Date: Aug. 26, 2021

(54) IMAGING APPARATUS AND CONTROL METHOD

(71) Applicant: CANON KABUSHIKI KAISHA, Tokyo (JP)

(72) Inventors: Seiji Ogawa, Tokyo (JP); Akane Sakamoto, Tokyo (JP); Miyu Fukushima, Tokyo (JP)

(21) Appl. No.: 17/176,702

(22) Filed: Feb. 16, 2021

(30) Foreign Application Priority Data
Feb. 21, 2020 (JP) 2020-028055

(51) Int. Cl. G09B 19/00; G06F 3/14; G06F 3/0482; H04N 7/06; H04N 5/232; G09B 5/02

(52) U.S. Cl. CPC G09B 19/003; G06F 3/14; G09B 5/02; H04N 7/06; H04N 5/232933; G06F 3/0482

(57) ABSTRACT

An imaging apparatus includes an image capture unit, a management unit configured to manage a mission regarding image capturing, a communication unit configured to transmit an image captured based on the mission to an external apparatus and receive an evaluation of the transmitted image, and a display unit configured to perform a display indicating progress of the mission managed by the management unit, based on the received evaluation.

### BACKGROUND

### Field of the Disclosure

Aspects of the disclosure generally relate to an imaging apparatus transmitting a captured image to an external apparatus, and a control method thereof.

### Description of the Related Art

Conventionally, a learning support system that distributes a learning material to a terminal such as a personal computer or a tablet device has been discussed. Japanese Patent Application Laid-Open No. 2006-337495 discusses a learning support system that distributes a learning material based on the skill level and learning progress of a user in order to give a sense of accomplishment of learning objectives to the user.

The learning support system discussed in Japanese Patent Application Laid-Open No. 2006-337495 distributes an English word question or a crossword puzzle as a learning material, and does not distribute the assignment content to be accomplished by the user performing image capturing.

### SUMMARY

According to some embodiments, there is provided a system, an apparatus, or a method for distributing assignment content regarding image capturing (hereinafter referred to as an image capturing mission) to a terminal, and prompting a user to perform image capturing.

According to some embodiments, an imaging apparatus includes an image capture unit, a management unit configured to manage a mission regarding image capturing, a communication unit configured to transmit an image captured based on the mission to an external apparatus, and receive an evaluation of the transmitted image, and a display unit configured to perform a display indicating progress of the mission managed by the management unit, based on the received evaluation.

According to some embodiments, a method includes managing a mission regarding image capturing, transmitting an image captured based on the mission to an external apparatus, receiving an evaluation of the transmitted image, and performing a display indicating progress of the managed mission, based on the received evaluation.

Further aspects of the embodiments will become apparent from the following description of exemplary embodiments.

### BRIEF DESCRIPTION OF THE DRAWINGS

FIG. 1A is a block diagram illustrating a configuration of a digital camera according to an exemplary embodiment. FIGS. 1B and 1C are diagrams each illustrating an external appearance of the digital camera according to the exemplary embodiment.

FIG. 2A is a block diagram illustrating a configuration of a mobile phone according to the exemplary embodiment. FIG. 2B is a diagram illustrating an external appearance of the mobile phone according to the exemplary embodiment.

FIG. 3 is a diagram illustrating a network configuration according to the exemplary embodiment.

FIG. 4 is a flowchart illustrating an application startup process performed by the mobile phone according to the exemplary embodiment.

FIGS. 5A to 5C are diagrams each illustrating an example of a screen displayed in the application startup process performed by the mobile phone according to the exemplary embodiment.

FIG. 6 is a flowchart illustrating an application home screen process performed by the mobile phone according to the exemplary embodiment.

FIGS. 7A to 7E are diagrams each illustrating an example of a screen displayed in the application home screen process performed by the mobile phone according to the exemplary embodiment.

FIG. 8 is a flowchart illustrating a mission evaluation process performed by the mobile phone according to the exemplary embodiment.

FIGS. 9A to 9C are diagrams each illustrating an example of a screen displayed in the mission evaluation process performed by the mobile phone according to the exemplary embodiment.

FIG. 10 is a flowchart illustrating a startup process performed by the digital camera according to the exemplary embodiment.

FIG. 11 is a diagram illustrating an example of a screen displayed in the startup process performed by the digital camera according to the exemplary embodiment.

FIG. 12 is a flowchart illustrating a mission mode process performed by the digital camera according to the exemplary embodiment.

FIGS. 13A to 13G are diagrams each illustrating an example of a screen displayed in the mission mode process performed by the digital camera according to the exemplary embodiment.

FIG. 14 is a flowchart illustrating a status display process performed by the digital camera according to the exemplary embodiment.

FIGS. 15A to 15E are diagrams each illustrating an example of a screen displayed in the status display process performed by the digital camera according to the exemplary embodiment.

FIG. 16 is a flowchart illustrating a collection mode process performed by the digital camera according to the exemplary embodiment.

FIGS. 17A to 17H are diagrams each illustrating an example of a screen displayed in the collection mode process performed by the digital camera according to the exemplary embodiment.

### DESCRIPTION OF THE EMBODIMENTS

Exemplary embodiments, features, and aspects of the disclosure will be described below with reference to the drawings. However, aspects of the disclosure are not limited to the following embodiments.

The exemplary embodiments described below are examples of the present disclosure, and may be appropriately modified or changed depending on the configuration of an apparatus to which any of the exemplary embodiments is applied, and various conditions.

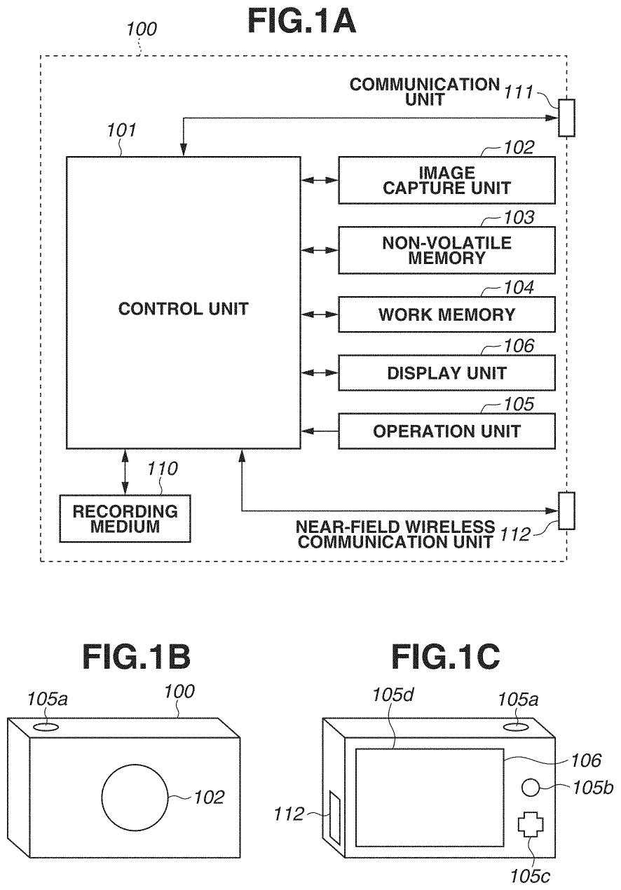

FIG. 1A is a block diagram illustrating an example of a configuration of a digital camera 100, which is an example of an imaging apparatus according to an exemplary embodiment. While in the exemplary embodiment, the digital camera 100 is described as an example of the imaging apparatus, the imaging apparatus is not limited thereto. The imaging apparatus only needs to have an image capturing function, and may be an information processing apparatus such as a smartphone, a tablet device, or a personal computer.

A control unit 101 controls each component of the digital camera 100 based on an input signal and a program to be described below. Instead of the control unit 101 controlling the entire digital camera 100, a plurality of hardware may share processes, thereby controlling the entire digital camera 100.

An image capture unit 102 includes, for example, an optical lens unit, an optical system for controlling the aperture, zoom, and focus, and an image sensor for converting light incident thereon through the optical lens unit into an electrical video signal. As the image sensor, a complementary metal-oxide-semiconductor (CMOS) sensor or a charge-coupled device (CCD) sensor is generally used.

The image capture unit 102, which is controlled by the control unit 101, causes the image sensor to convert a formed subject light image into an electric signal, and performs a noise reduction process on the electric signal and outputs image data as digital data. The digital camera 100 according to the exemplary embodiment records the image data in a recording medium 110 in compliance with, for example, the Design Rule for Camera File system (DCF) standard.

A non-volatile memory 103 is electrically erasable and recordable, and stores a program (described below) to be executed by the control unit 101.

A work memory 104 is used as a buffer memory for temporarily holding image data of an image captured by the image capture unit 102, an image display memory for a display unit 106, and a work area for the control unit 101.

An operation unit 105 receives from a user an instruction to operate the digital camera 100. The operation unit 105 includes, for example, a power button for the user to give an instruction to turn on or off the digital camera 100, a release switch 105a (refer to FIG. 1C) for giving an instruction to capture an image, and a reproduction button 105b (refer to FIG. 1C) for giving an instruction to reproduce image data. The operation unit 105 further includes operation members such as a connection button for wirelessly connecting to an external information terminal via a communication unit 111 (described below) to initiate communication.

The operation unit 105 may include a touch panel 105d (refer to FIG. 1C) formed on the display unit 106. The release switch 105a includes switches SW1 and SW2. When the release switch 105a is pressed halfway, the switch SW1 is turned on. Accordingly, the operation unit 105 receives an instruction to make an image capturing preparation such as an autofocus (AF) process, an automatic exposure (AE) process, an automatic white balance (AWB) process, or a pre-flash (EF) process. When the release switch 105a is pressed completely, the switch SW2 is turned on. Accordingly, the operation unit 105 receives an instruction to capture an image.

The display unit 106 displays a viewfinder image in image capturing, reproduces and displays captured image data, and displays characters for performing an interactive operation with the user. The display unit 106 does not necessarily need to be built into the digital camera 100. The digital camera 100 only needs to be able to connect to the display unit 106 inside or outside the digital camera 100, and have at least the function of controlling the display of the display unit 106. For example, the control unit 101 can be configured to have this display control function and function as a display control unit.

The recording medium 110 records image data output from the image capture unit 102. The recording medium 110 may be configured to be attachable to or detachable from the digital camera 100, or may be built into the digital camera 100. The digital camera 100 only needs to have at least a method for accessing the recording medium 110.

The communication unit 111 is an interface for wirelessly connecting to an information terminal as an external apparatus. The digital camera 100 according to the exemplary embodiment can transmit or receive image data to or from the information terminal via the communication unit 111. For example, the digital camera 100 can transmit image data generated by the image capture unit 102 to the information terminal via the communication unit 111. The image capturing by the image capture unit 102 may be controlled from the information terminal via the communication unit 111. In the exemplary embodiment, the communication unit 111 includes an interface for communicating with the information terminal via a wireless local area network (LAN) compliant with the Institute of Electrical and Electronics Engineers (IEEE) 802.11 standard. The control unit 101 controls the communication unit 111 to implement wireless communication with the information terminal.

A near-field wireless communication unit 112 includes, for example, an antenna for wireless communication, a modulation/demodulation circuit for processing a wireless signal, and a communication controller. The near-field wireless communication unit 112 outputs a modulated wireless signal from the antenna and demodulates a wireless signal received by the antenna, thereby implementing near-field wireless communication compliant with the IEEE 802.15 standard (i.e., Bluetooth®).

In the exemplary embodiment, Bluetooth® communication employs Bluetooth® Low Energy version 4.0, which consumes low energy. In Bluetooth® Low Energy communication, the range where communication can be performed is narrower (i.e., the distance within which communication can be performed is shorter) than that in wireless LAN communication. In addition, the communication speed of Bluetooth® Low Energy communication is slower than that of wireless LAN communication. Meanwhile, in Bluetooth® Low Energy communication, power consumption is lower than in wireless LAN communication. The digital camera 100 can transmit or receive data to or from the external apparatus via the near-field wireless communication unit 112. For example, the image capturing by the image capture unit 102 of the digital camera 100 may be controlled from the information terminal via the near-field wireless communication unit 112. However, since the communication speed is slow, image data generated by the image capture unit 102 is not transmitted via the near-field wireless communication unit 112.

The communication unit 111 of the digital camera 100 has an access point (AP) mode where the digital camera 100 operates as an access point in an infrastructure mode, and a client (CL) mode where the digital camera 100 operates as a client in the infrastructure mode.

When the digital camera 100 causes the communication unit 111 to operate in the CL mode, the digital camera 100 can operate as a CL device in the infrastructure mode. The digital camera 100 operating as the CL device connects to an AP device near the digital camera 100, so that the digital camera 100 can participate in a network formed by the AP device.

When the digital camera 100 causes the communication unit 111 to operate in the AP mode, the digital camera 100 can operate as a simple AP, which is a type of AP but has more limited functions. The digital camera 100 operating as the simple AP forms a wireless network using the digital camera 100 itself as an access point. An apparatus near the digital camera 100 can recognize the digital camera 100 as an AP device and participate in the network formed by the digital camera 100. A program for operating the digital camera 100 as described above is held in the non-volatile memory 103.

The digital camera 100 operating in the AP mode is a simple AP that does not have a gateway function for transferring data received from a CL device to an Internet provider. Thus, even if the digital camera 100 receives data from another apparatus participating in the network formed by the digital camera 100, the digital camera 100 cannot transfer the data to a network such as the Internet.

Next, an external appearance of the digital camera 100 will be described. FIGS. 1B and 1C are diagrams each illustrating an example of the external appearance of the digital camera 100.

The release switch 105a, the reproduction button 105b, a direction key 105c, and the touch panel 105d are operation members included in the operation unit 105. The display unit 106 reproduces and displays an image obtained as a result of the image capturing by the image capture unit 102. The digital camera 100 includes the antenna of the near-field wireless communication unit 112 on the side surface of the camera housing. The near-field wireless communication unit 112 of the digital camera 100 is brought close to the near-field wireless communication unit 112 of another device within a certain distance, so that the digital camera 100 can establish near-field wireless communication with another device. As a result, the digital camera 100 can communicate with another device in a contactless manner not via a cable and also limit communication partners based on the user's intention.

The above is the description of the digital camera 100.

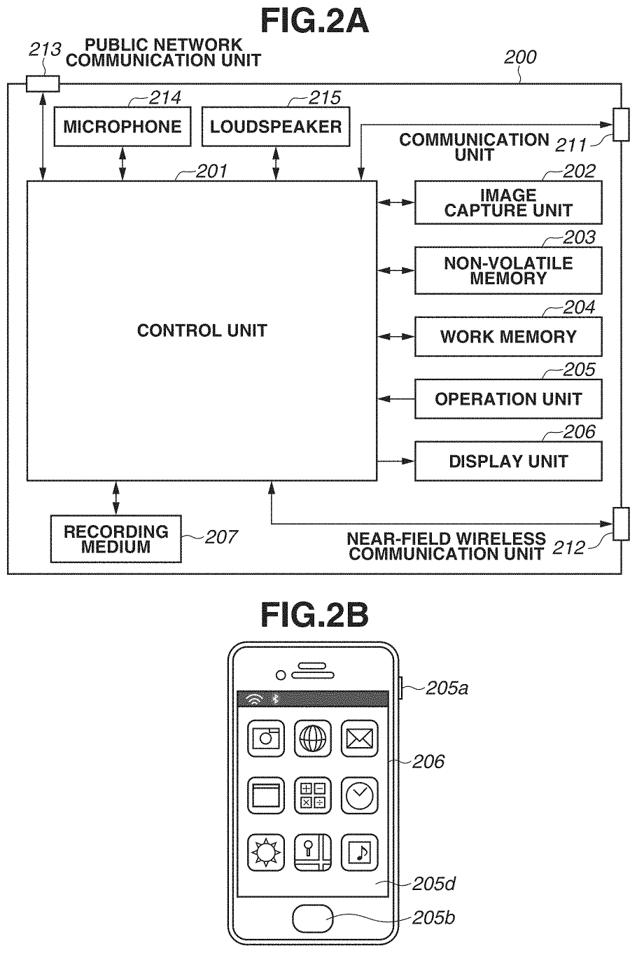

FIG. 2A is a block diagram illustrating an example of a configuration of a mobile phone 200, which is an example of an information terminal as an external apparatus according to the exemplary embodiment. While in the exemplary embodiment, the mobile phone 200 is described as an example of the information terminal, the information terminal is not limited thereto. The information terminal may be, for example, a digital camera having a wireless function, a tablet device, a smartphone, or a personal computer.

A control unit 201 controls each component of the mobile phone 200 based on an input signal and a program to be described below. Instead of the control unit 201 controlling the entire mobile phone 200, a plurality of hardware may share processes, thereby controlling the entire mobile phone 200.

An image capture unit 202 converts a subject light image formed by a lens included in the image capture unit 202 into an electric signal, performs a noise reduction process on the electric signal, and outputs image data as digital data. The captured image data is stored in a buffer memory, then subjected to a predetermined calculation by the control unit 201, and recorded in a recording medium 207.

A non-volatile memory 203 is electrically erasable and recordable. In the non-volatile memory 203, an operating system (OS), which is basic software to be executed by the control unit 201, and an application that cooperates with the OS to implement an applicative function are recorded. In the non-volatile memory 203, a camera application to be described below is stored.

A work memory 204 is used as an image display memory for a display unit 206 and a work area for the control unit 201.

An operation unit 205 receives from a user an instruction to operate the mobile phone 200. The operation unit 205 includes, for example, a power button 205a (refer to FIG. 2B) for the user to give an instruction to turn on or off the mobile phone 200, and operation members such as a touch panel 205d (refer to FIG. 2B) formed on the display unit 206.

The display unit 206 reproduces and displays image data, and displays characters for performing an interactive operation with the user. The display unit 206 does not necessarily need to be built into the mobile phone 200. The mobile phone 200 only needs to be able to connect to the display unit 206 and have at least the function of controlling the display of the display unit 206.

The mobile phone 200 includes, as one of the operation members of the operation unit 205, the touch panel 205d capable of detecting contact with the display unit 206. The touch panel 205d and the display unit 206 are configured in an integrated manner. For example, the touch panel 205d is configured to have light transmittance that does not hinder the display of the display unit 206, and is made attachable to an upper layer of the display surface of the display unit 206. Then, input coordinates on the touch panel 205d are associated with display coordinates on the display unit 206. As a result, it is possible to configure a graphical user interface (GUI) as if the user could directly operate a screen displayed on the display unit 206. As the touch panel 205d, a touch panel using any of various methods such as a resistive method, a capacitive method, a surface acoustic wave method, an infrared method, an electromagnetic induction method, an image recognition method, and a photosensor method may be used.

The control unit 201 can detect the following operations on the touch panel 205d.

(1) Bringing a finger or a pen into contact with the touch panel 205d (hereinafter referred to as a “touch-down”)
(2) Keeping the finger or the pen in contact with the touch panel 205d (hereinafter referred to as a “touch-on”)
(3) Moving the finger or the pen while keeping the finger or the pen in contact with the touch panel 205d (hereinafter referred to as a “move”)
(4) Releasing from the touch panel 205d the finger or the pen being in contact with the touch panel 205d (hereinafter referred to as a “touch-up”)
(5) Bringing nothing into contact with the touch panel 205d (hereinafter referred to as a “touch-off”)

The display unit 206 acquires information regarding these operations and the positional coordinates where the finger or the pen is in contact with the touch panel 205d. Then, the display unit 206 notifies the control unit 201 of the information. Based on the information, the control unit 201 determines what operation is performed on the touch panel 205d. In the case of a move, the control unit 201 can also determine, based on changes in the positional coordinates, the moving direction of the finger or the pen on the touch panel 205d with respect to each of the vertical and horizontal components on the touch panel 205d. If the user performs a touch-down, a certain move, and a touch-up in a consecutive manner on the touch panel 205d, the user is regarded as drawing a stroke. Hereinafter, the operation of quickly drawing a stroke will be referred to as a flick. A flick is an operation of quickly moving the finger by some distance while keeping the finger on the touch panel 205d, and releasing the finger from the touch panel 205d immediately after the quick move. In other words, a flick is an operation of quickly tracing the touch panel 205d with the finger in a flipping manner. If a move performed by a predetermined distance or more at a predetermined speed or more is detected, and a touch-up is detected immediately after the move, the control unit 201 determines that a flick is performed. If a move performed by a predetermined distance or more at less than a predetermined speed is detected, the control unit 201 determines that a drag is performed.

The recording medium 207 records image data output from the image capture unit 202. The recording medium 207 may be configured to be attachable to or detachable from the mobile phone 200, or may be built into the mobile phone 200. The mobile phone 200 only needs to have at least a method for accessing the recording medium 207.

A communication unit 211 is an interface for wirelessly connecting to and communicating with the digital camera 100. The mobile phone 200 can transmit or receive data to or from the digital camera 100 via the communication unit 211. The communication unit 211 is an antenna, and the control unit 201 can connect to the digital camera 100 via the antenna.

The connection to the digital camera 100 may be a direct connection or a connection via an access point. As a protocol for data communication, for example, Picture Transfer Protocol over Internet Protocol (PTP/IP) via a wireless LAN can be used. The communication with the digital camera 100 is not limited thereto. For example, the communication unit 211 can include a wireless communication module such as an infrared communication module, a Bluetooth® communication module, or a Wireless Universal Serial Bus (USB) communication module.

A near-field wireless communication unit 212 includes, for example, an antenna for wireless communication, a modulation/demodulation circuit for processing a wireless signal, and a communication controller. The near-field wireless communication unit 212 outputs a modulated wireless signal from the antenna and demodulates a wireless signal received by the antenna, thereby implementing near-field wireless communication compliant with the IEEE 802.15 standard (i.e., Bluetooth®). In the exemplary embodiment, similarly to the configuration of the digital camera 100, Bluetooth® communication employs Bluetooth® Low Energy, which consumes low energy.

In near-field wireless communication with the digital camera 100, the mobile phone 200 first needs to connect to the near-field wireless communication unit 112 of the digital camera 100 by performing a pairing operation, which is an operation for establishing a one-to-one connection in near-field wireless communication. In the pairing operation, the digital camera 100 operates as a peripheral device in Bluetooth® Low Energy and periodically transmits a signal called an Advertise signal for notifying other devices about the presence of the digital camera 100, using the near-field wireless communication unit 112.

Then, the mobile phone 200 operates as a central device and performs a scan operation using the near-field wireless communication unit 212. Accordingly, the mobile phone 200 receives the Advertise signal from the digital camera 100, thereby finding the digital camera 100. When finding the digital camera 100, the mobile phone 200 performs an initiate operation to make a participation request, thereby establishing a connection for near-field wireless communication.

A public network communication unit 213 is an interface used to perform public wireless communication. The mobile phone 200 can make a telephone call with another device via the public network communication unit 213. At this time, the control unit 201 implements the telephone call by inputting and outputting sound signals via a microphone 214 and a loudspeaker 215. The public network communication unit 213 is an antenna, and the control unit 201 can connect to a public network via the antenna. A single antenna can be used both as the communication unit 211 and the public network communication unit 213.

Next, an external appearance of the mobile phone 200 will be described. FIG. 2B illustrates an example of the external appearance of the mobile phone 200. The power button 205a, a home button 205b, and the touch panel 205d are operation members included in the operation unit 205. By pressing the home button 205b, the user can suspend an application being performed, and display on the display unit 206 a home screen that allows the user to select another application.

In the mobile phone 200, a standard camera application is installed on the OS that controls the mobile phone 200. The camera application can automatically detect a Quick Response (QR) code (registered trademark) from a captured subject image to analyze the QR code and obtain a character string. The mobile phone 200 can recognize, from the character string, Wi-Fi network information or a Uniform Resource Locator (URL) which is information for accessing data.

The above is the description of the mobile phone 200.

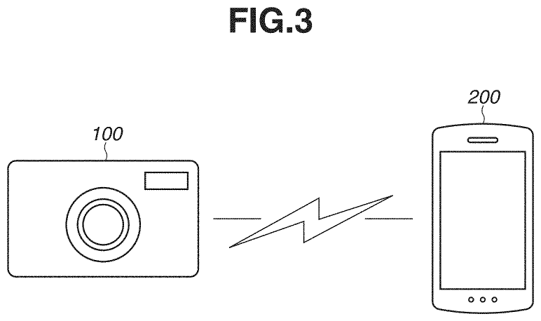

FIG. 3 is a diagram schematically illustrating a form of connection between the digital camera 100 and the mobile phone 200 according to the exemplary embodiment.

FIG. 3 illustrates a form in which the digital camera 100 and the mobile phone 200 are directly connected to each other. In this case, the digital camera 100 operates as a simple AP and forms a wireless LAN network. When operating as the simple AP, the digital camera 100 starts periodical transmission of a beacon signal. The mobile phone 200 detects the beacon signal and participates in the wireless LAN network formed by the digital camera 100. Then, the digital camera 100 and the mobile phone 200 find each other and acquire each other's capability information, thereby establishing communication and entering the state where the digital camera 100 and the mobile phone 200 can transmit or receive data to or from each other.

The digital camera 100 has two modes, namely a “mission mode” and a “collection mode”. The mobile phone 200 has an application (hereinafter referred to as a communication application) that manages the “mission mode” and the “collection mode”, and communicates with the digital camera 100 operating in the “mission mode” or the “collection mode” to transmit or receive information to or from the digital camera 100.

An overview of the “mission mode” and the “collection mode” will be described next.

The “mission mode” is a mode for capturing images using the digital camera 100 based on an image capturing mission transmitted from the mobile phone 200. This assumes a use case where a parent uses the mobile phone 200 to transmit an image capturing mission, which the parent wishes to assign to a child, to the digital camera 100, and the child operates the digital camera 100 to capture images and complete the image capturing mission. More specifically, the mission mode is performed by the following procedure. In the following description, an “image capturing mission” will be referred to simply as a “mission”.

(1) The parent operates the mobile phone 200 to select a mission that the parent wishes to assign to the child and then transmit the mission to the digital camera 100.
(2) The child operates the digital camera 100 to capture images based on the received mission. A single mission includes tasks, and each task gives an instruction to capture a still image.
(3) When image capturing is completed for all the tasks, the digital camera 100 enters the state where the digital camera 100 can submit mission data to the mobile phone 200. In this state, the child operates the digital camera 100 to submit mission data to the mobile phone 200. More specifically, the mission data is submitted by transmitting a captured image obtained by the image capturing for each task.
(4) The parent evaluates the submitted mission data. More specifically, the parent uses the mobile phone 200 to check and evaluate the captured image for each task (on a pass/fail basis, for example). If the captured image is in accordance with the content of the task, the parent evaluates the task as “pass”.
(5) The evaluation is fed back from the mobile phone 200 to the digital camera 100. If all the tasks are evaluated as “pass”, the digital camera 100 treats the mission as completed. The digital camera 100 manages mission completion points. Every time a mission is completed, the digital camera 100 increments the number of mission completion points by “plus 1”.
(6) When the mission is completed, the digital camera 100 can receive a present as a reward from the mobile phone 200. The reception of the reward will be described below.

Specific examples of the mission include the following. Each mission prompts the user to capture a still image or a moving image based on a theme. As described above, a single mission includes one to about six tasks, and the tasks are related to each other.
A mission that presents a color and prompts the user to capture an image of a subject with the same color as the presented color
A mission that displays text and prompts the user to capture an image of a subject corresponding to the content of the text
A mission that presents an emoji and prompts the user to capture an image of a subject with the same expression as the emoji (hereinafter, this mission will be referred to as an “emoji photo mission” and used as a specific example)

Next, an overview of the “collection mode” will be described.

The “collection mode” is a mode for repeating image capturing under a theme set by the user without determining the number of images. In other words, in the “collection mode”, unlike the “mission mode”, an image capturing target is not designated. More specifically, the “collection mode” is a mode for the child to voluntarily set the theme of a subject and capturing images under the theme. Also in the “collection mode”, the parent can use the mobile phone 200 to check an image captured by the child.

In either mode, the parent and the child can communicate with each other through image capturing, and the digital camera 100 and the mobile phone 200 function as communication tools. By actually capturing images using the digital camera 100, the child can not only master camera operation, but also acquire own knowledge and cultivate sensitivity through image capturing experience.

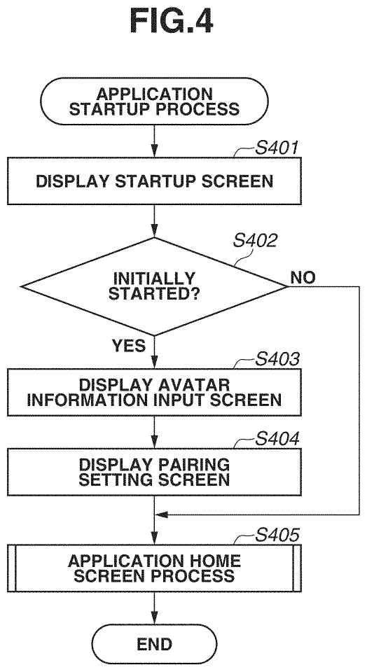

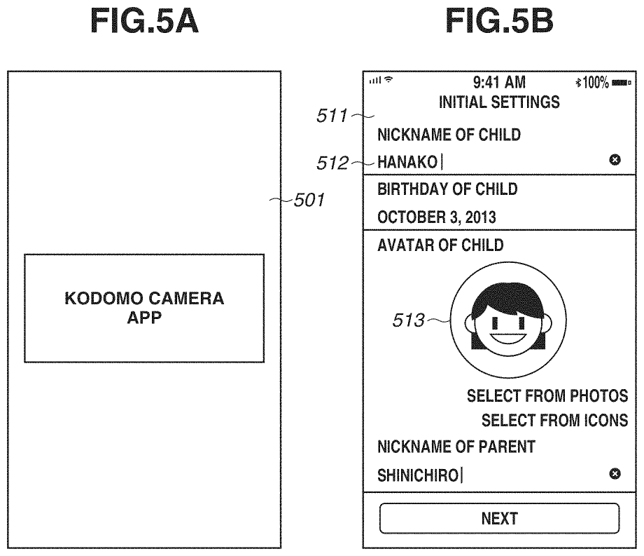

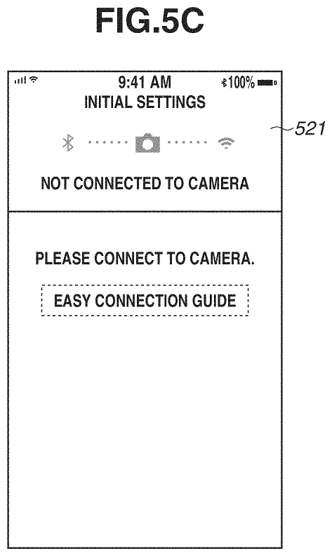

With reference to FIGS. 4 and 5A to 5C, an application startup process performed when the mobile phone 200 starts the communication application will be described next. FIG. 4 is a flowchart illustrating the application startup process performed by the mobile phone 200. Each of FIGS. 5A to 5C illustrates an example of a screen displayed in the application startup process by the mobile phone 200.

In step S401, when the control unit 201 reads the communication application from the non-volatile memory 203 and executes the application, a startup screen 501 is displayed on the display unit 206. FIG. 5A illustrates an example of the startup screen 501.

In step S402, the control unit 201 determines whether the communication application is initially started. If the communication application is initially started (YES in step S402), the process of FIG. 4 proceeds to step S403. If not (NO in step S402), the process of FIG. 4 proceeds to step S405.

In step S403, the control unit 201 displays on the display unit 206 an avatar information input screen 511 as a screen for inputting information regarding the user of the digital camera 100 (hereinafter referred to as “avatar information”). FIG. 5B illustrates an example of the avatar information input screen 511. On the avatar information input screen 511, the name (nickname) of the child who is the user of the digital camera 100 can be entered into a name entry field 512, and an avatar can be set using an avatar image 513.

In step S404, the control unit 201 displays on the display unit 206 a pairing setting screen 521 as a screen for setting pairing with the digital camera 100. When pairing with the digital camera 100 is set, the mobile phone 200 communicates with the digital camera 100 via the communication unit 211 and performs the pairing. FIG. 5C illustrates an example of the pairing setting screen 521. When the pairing is completed, setting information regarding the avatar set in step S403 is transmitted to the digital camera 100, and the setting of the avatar is reflected in the digital camera 100.

In step S405, the control unit 201 performs a application home screen process (described below).

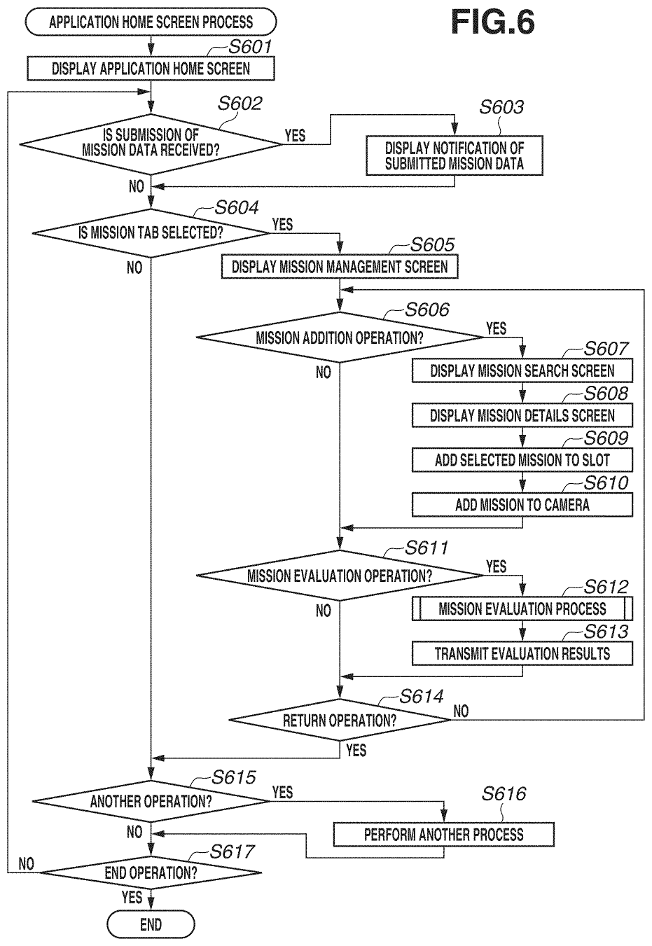

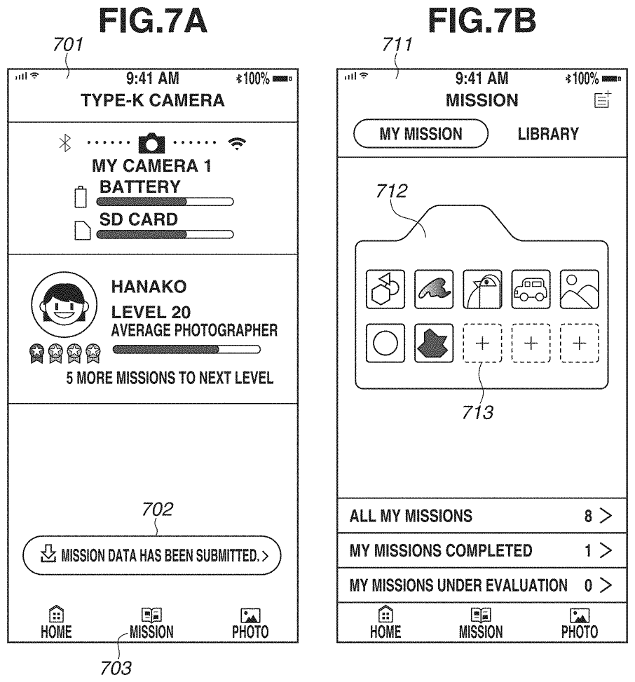

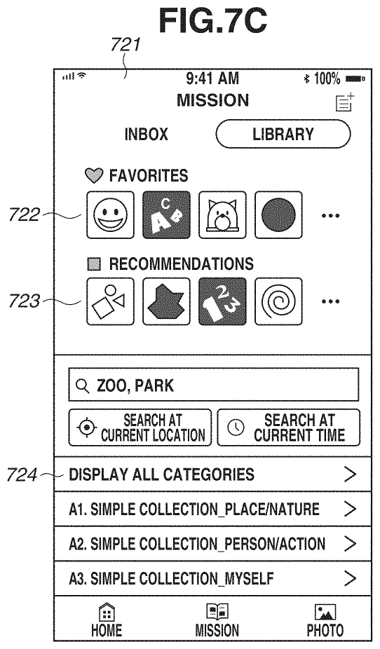

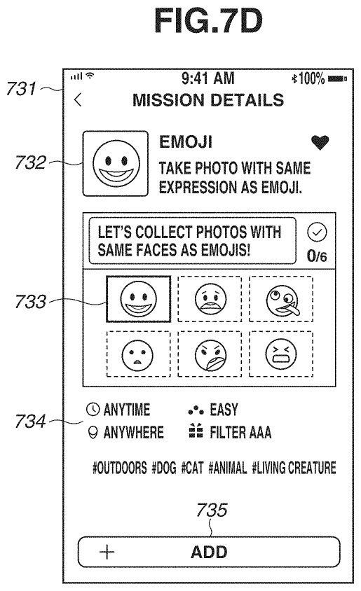

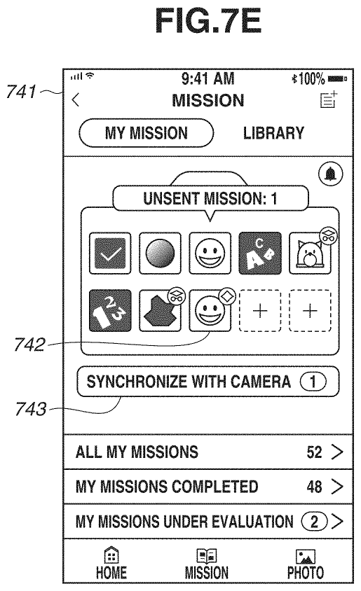

With reference to FIGS. 6 and 7A to 7E, the communication application home screen process performed by the mobile phone 200 will be described next. FIG. 6 is a flowchart illustrating the communication application home screen process for executing the communication application by the mobile phone 200. FIGS. 7A to 7E illustrate examples of a home screen and other screens of the communication application in the mobile phone 200.

In step S601, the control unit 201 displays an application home screen 701 on the display unit 206. FIG. 7A illustrates an example of the application home screen 701. In a lower portion of the application home screen 701, a mission tab button 703 used to transition to a screen for performing an operation regarding a mission is displayed.

In step S602, the control unit 201 determines whether the submission of mission data is received from the digital camera 100. If mission data is submitted (YES in step S602), the process of FIG. 6 proceeds to step S603. If not (NO in step S602), the process of FIG. 6 proceeds to step S604.

In step S603, the control unit 201 displays on the display unit 206 a notification indicating that mission data has been submitted. The display unit 206 displays a submitted mission data notification 702 in a superimposed manner on the application home screen 701. Alternatively, the notification may be given by another method such as a sound.

In step S604, the control unit 201 determines whether the mission tab button 703 is selected. If the mission tab button 703 is selected (YES in step S604), the process of FIG. 6 proceeds to step S605. If not (NO in step S604), the process of FIG. 6 proceeds to step S615.

In step S605, the control unit 201 displays on the display unit 206 a mission management screen 711 for managing missions for the digital camera 100. FIG. 7B illustrates an example of the mission management screen 711. The mission management screen 711 displays a mission list 712 indicating missions added to the digital camera 100. In empty slots in the mission list 712, mission addition buttons 713 are displayed.

In step S606, the control unit 201 determines whether an operation for adding a mission is performed on the operation unit 205. If the operation is performed (YES in step S606), the process of FIG. 6 proceeds to step S607. If not (NO in step S606), the process of FIG. 6 proceeds to step S611.

In step S607, the control unit 201 displays a mission search screen 721 on the display unit 206. FIG. 7C illustrates an example of the mission search screen 721. The mission search screen 721 displays user's favorite missions 722 and application recommended missions 723. Alternatively, the user may search category selection 724 for a desired mission.

In step S608, the control unit 201 displays a mission details screen 731 indicating the details of a mission selected by the user. FIG. 7D illustrates an example of the mission details screen 731. The mission details screen 731 displays a representative icon 732 of the mission, tasks 733 included in the mission, categories 734 of the mission, and a mission addition button 735. If the mission addition button 735 is operated, the process of FIG. 6 proceeds to step S609.

In step S609, the control unit 201 adds, to a slot, the mission to be transmitted to the digital camera 100. FIG. 7E illustrates an example of a mission management screen 741 where a mission 742 is added to a slot. In this state, the mission 742 added to the slot is unsent. The mission management screen 741 displays the mission 742 with an unsent icon, and a synchronize button 743 for transmitting the mission 742 to the digital camera 100. When the synchronize button 743 is operated, the process of FIG. 6 proceeds to step S610.

In step S610, the control unit 201 transmits the mission 742 added to the slot to the digital camera 100 via the communication unit 211.

In step S611, the control unit 201 determines whether a mission evaluation operation is performed on the operation unit 205. If the mission evaluation operation is performed (YES in step S611), the process of FIG. 6 proceeds to step S612. If not (NO in step S611), the process of FIG. 6 proceeds to step S614.

In step S612, the control unit 201 performs a mission evaluation process for evaluating the mission data submitted from the digital camera 100. The mission evaluation process will be described below.

In step S613, the control unit 201 transmits the evaluation results of the mission to the digital camera 100.

In step S614, the control unit 201 determines whether an operation for returning to the home screen is performed on the operation unit 205. If the operation for returning to the home screen is performed (YES in step S614), the process of FIG. 6 proceeds to step S615. If not (NO in step S614), the process of FIG. 6 proceeds to step S606.

In step S615, the control unit 201 determines whether another operation is performed on the home screen. If another operation is performed (YES in step S615), the process of FIG. 6 proceeds to step S616. If not (NO in step S615), the process of FIG. 6 proceeds to step S617.

In step S616, the control unit 201 performs another process. A move to another tab is made in this step.

In step S617, the control unit 201 determines whether an end operation is performed. If the end operation is performed (YES in step S617), the process of FIG. 6 ends. If not (NO in step S617), the process of FIG. 6 proceeds to step S602.

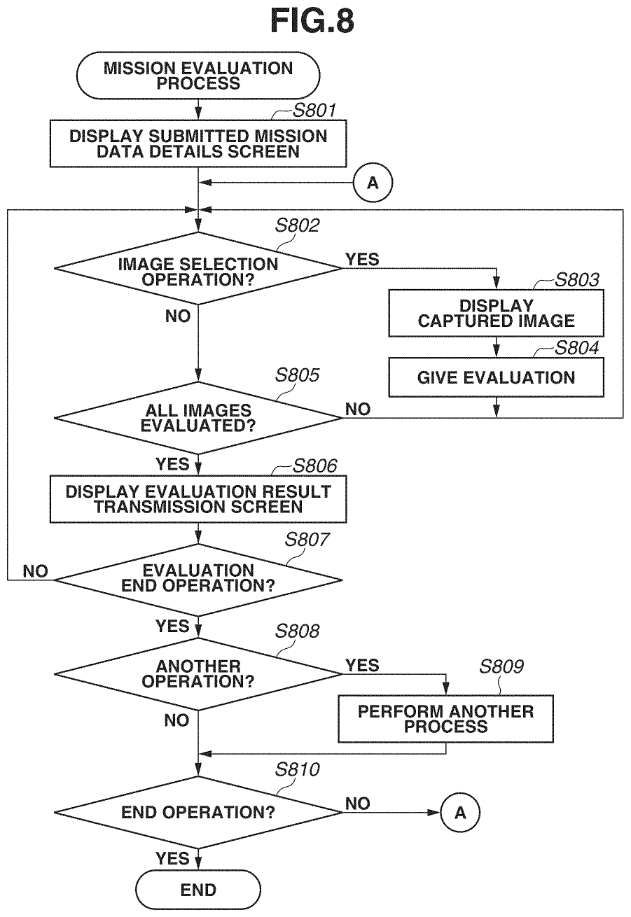

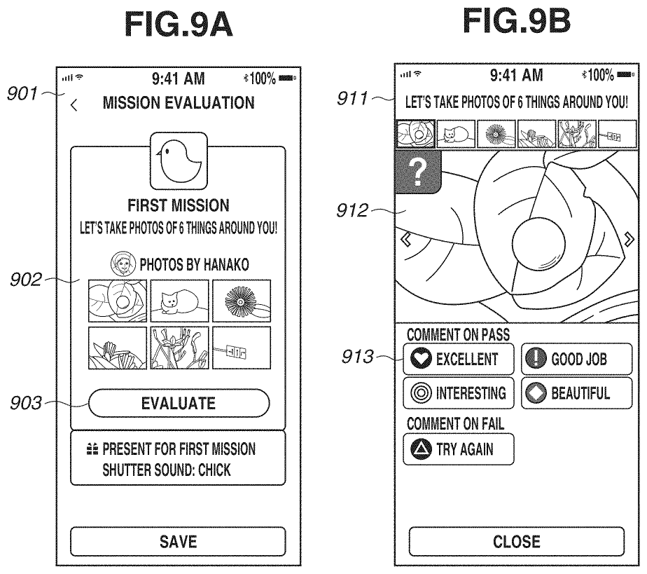

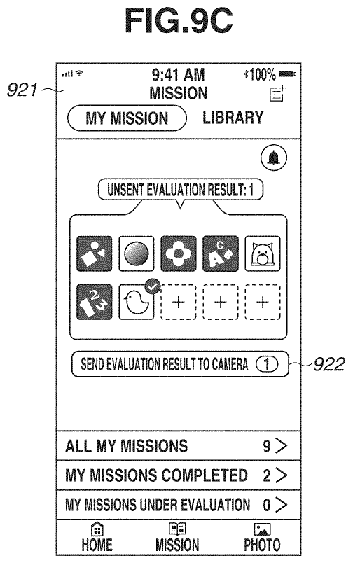

With reference to FIGS. 8 and 9A to 9C, the mission evaluation process performed by the mobile phone 200 will be described next. FIG. 8 is a flowchart illustrating the mission evaluation process performed by the mobile phone 200. Each of FIGS. 9A to 9C illustrates an example of a mission evaluation screen displayed by the mobile phone 200.

In step S801, the control unit 201 displays on the display unit 206 a submitted mission data details screen 901 indicating the details of the mission data submitted from the digital camera 100. FIG. 9A illustrates an example of the submitted mission data details screen 901. The submitted mission data details screen 901 displays images 902 captured for the respective tasks in the mission, and an evaluate button 903 for starting the evaluation (grading).

In step S802, the control unit 201 determines whether the evaluate button 903 is operated. If the evaluate button 903 is selected (YES in step S802), the process of FIG. 8 proceeds to step S803. If not (NO in step S802), the process of FIG. 8 proceeds to step S805.

In step S803, the control unit 201 displays one of the images 902 captured for the selected mission in an enlarged manner for evaluation. FIG. 9B illustrates an example of an image evaluation screen 911. The image evaluation screen 911 displays a captured image 912 in an enlarged manner and also displays, below the captured image 912, buttons 913 for evaluating the image. In the exemplary embodiment, the image can be evaluated as “pass” or “fail”, and a comment can be added if the image is evaluated as “pass”.

In step S804, the control unit 201 gives an evaluation corresponding to a pressed button among the buttons 913, to the captured image 912.

In step S805, the control unit 201 determines whether all the images included in the images 902 are evaluated. If all the images are evaluated (YES in step S805), the process of FIG. 8 proceeds to step S806. If not (NO in step S805), the process of FIG. 8 proceeds to step S802.

In step S806, the control unit 201 displays an evaluation result transmission screen 921. FIG. 9C illustrates an example of the evaluation result transmission screen 921. The evaluation result transmission screen 921 displays an evaluation result transmission button 922 for transmitting the evaluation results to the digital camera 100.

In step S807, the control unit 201 determines whether the evaluation result transmission button 922 is operated. If the evaluation result transmission button 922 is operated (YES in step S807), the control unit 201 transmits the evaluation results. Then, the process of FIG. 8 proceeds to step S808. If not (NO in step S807), the process of FIG. 8 proceeds to step S802.

In step S808, the control unit 201 determines whether another operation is performed. If another operation is performed (YES in step S808), the process of FIG. 8 proceeds to step S809. If not (NO in step S808), the process of FIG. 8 proceeds to step S810.

In step S809, the control unit 201 performs another process.

In step S810, the control unit 201 determines whether an end operation is performed. If the end operation is performed (YES in step S810), the process of FIG. 8 ends. If not (NO in step S810), the process of FIG. 8 proceeds to step S802.

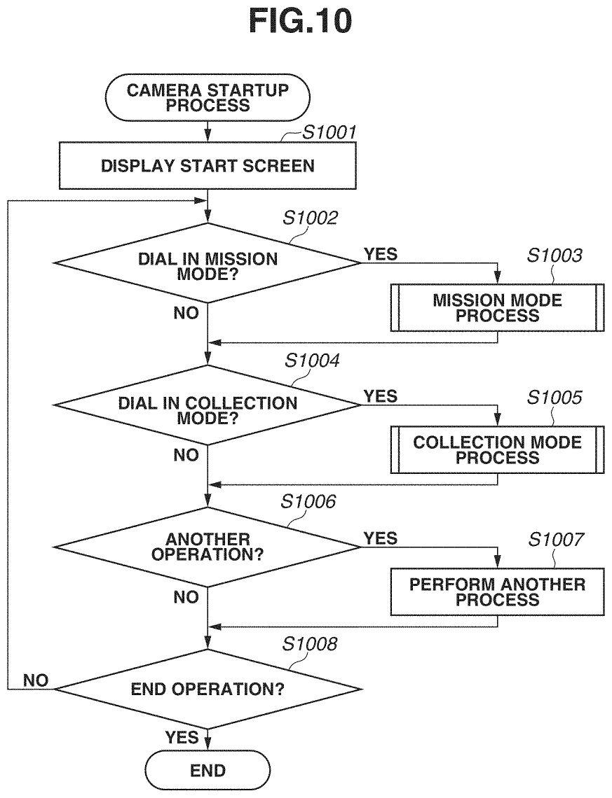

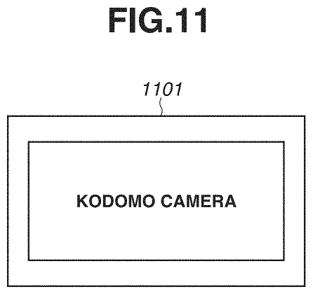

With reference to FIGS. 10 and 11, a startup process performed by the digital camera 100 will be described next. FIG. 10 is a flowchart illustrating the startup process performed by the digital camera 100. FIG. 11 illustrates an example of a startup screen 1101 displayed by the digital camera 100.

In step S1001, the control unit 101 displays the startup screen 1101 on the display unit 106.

In step S1002, the control unit 101 determines whether a mode dial included in the operation unit 105 is at a mission mode position. If the mode dial is at the mission mode position (YES in step S1002), the process of FIG. 10 proceeds to step S1003. If not (NO in step S1002), the process of FIG. 10 proceeds to step S1004.

In step S1003, the control unit 101 performs a mission mode process (described below).

In step S1004, the control unit 101 determines whether the mode dial included in the operation unit 105 is at a collection mode position. If the mode dial is at the collection mode position (YES in step S1004), the process of FIG. 10 proceeds to step S1005. If not (NO in step S1004), the process of FIG. 10 proceeds to step S1006.

In step S1005, the control unit 101 performs a collection mode process (described below).

In step S1006, the control unit 101 determines whether another operation is performed. If another operation is performed (YES in step S1006), the process of FIG. 10 proceeds to step S1007. If not (NO in step S1006), the process of FIG. 10 proceeds to step S1008.

In step S1007, the control unit 101 performs another process. For example, the control unit 101 can perform an operation such as a normal image capturing operation not related to the mission mode or the collection mode. In a case where a normal image capturing operation is performed, a setting for applying an image capturing frame obtained as a reward (present) may be enabled.

In step S1008, the control unit 101 determines whether an end operation is performed. If the end operation is performed (YES in step S1008), the process of FIG. 10 ends. If not (NO in step S1008), the process of FIG. 10 proceeds to step S1002.

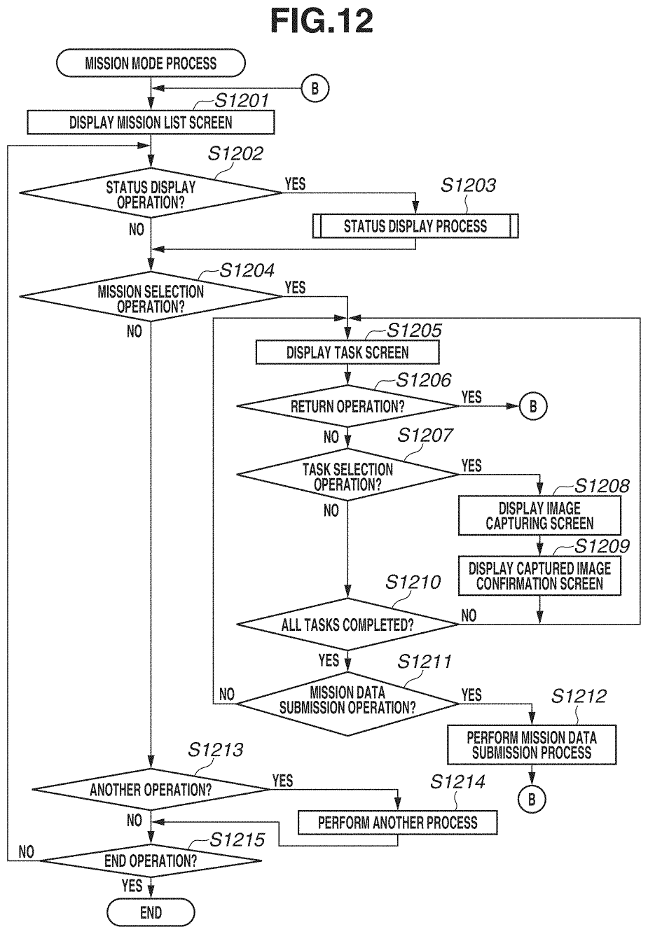

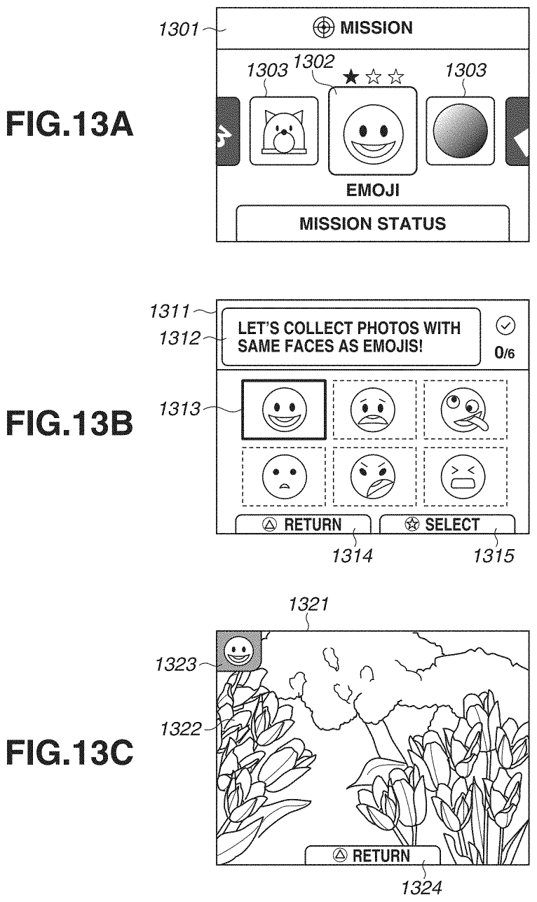

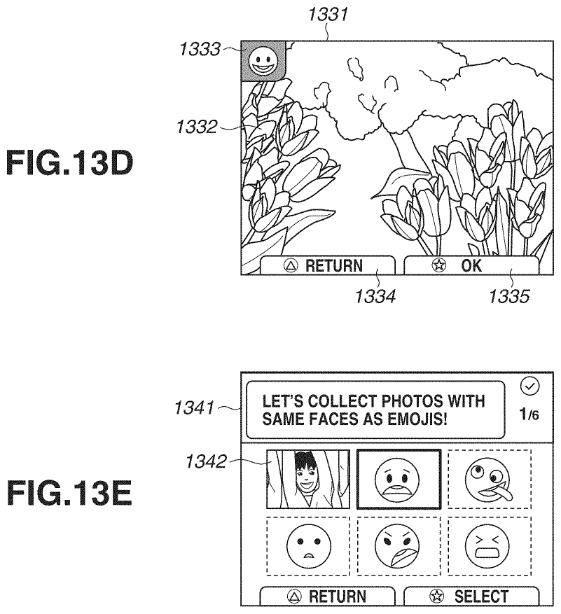

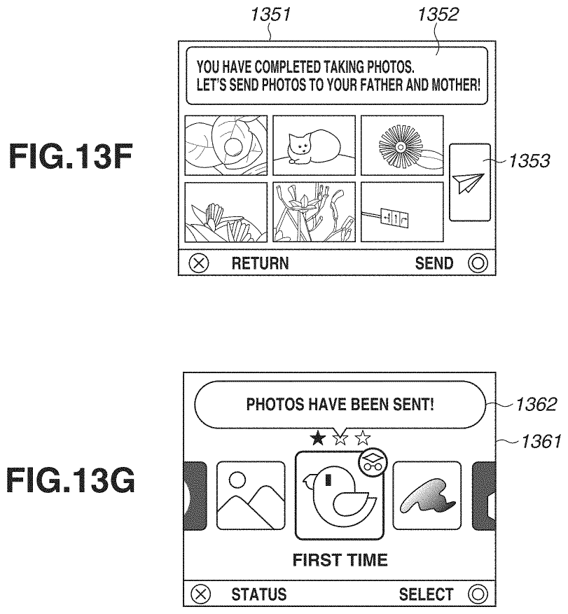

With reference to FIGS. 12 and 13A to 13G, the mission mode process performed by the digital camera 100 will be described next. FIG. 12 is a flowchart illustrating the process of FIG. 12 for performing the mission mode by the digital camera 100. Each of FIGS. 13A to 13G illustrates an example of a screen displayed when the mission mode is performed by the digital camera 100.

In step S1201, the control unit 101 displays on the display unit 106 a mission list screen 1301 indicating a list of missions installed on the digital camera 100. FIG. 13A illustrates an example of the mission list screen 1301. The mission list screen 1301 displays various missions including an emoji photo mission 1302 and other missions 1303. Hereinafter, a description will be given using an example where the emoji photo mission 1302 is selected.

In step S1202, the control unit 101 determines whether a mission status display operation is performed using the operation unit 105. If the operation is performed (YES in step S1202), the process of FIG. 12 proceeds to step S1203. If not (NO in step S1202), the process of FIG. 12 proceeds to step S1204.

In step S1203, the control unit 101 performs a status display process (described below).

In step S1204, the control unit 101 determines whether a mission selection operation is performed using the operation unit 105. If the operation is performed (YES in step S1204), the process of FIG. 12 proceeds to step S1205. If not (NO in step S1204), the process of FIG. 12 proceeds to step S1213.

In step S1205, the control unit 101 displays a task list screen 1311 on the display unit 106. FIG. 13B illustrates an example of the task list screen 1311. The task list screen 1311 displays a description 1312 for describing the mission, task icons 1313 indicating the respective tasks, a return button 1314 for performing an operation to return to the previous screen, and a select button 1315 for performing an operation to select a task.

In step S1206, the control unit 101 determines whether the return button 1314 is operated. If the return button 1314 is operated (YES in step S1206), the process of FIG. 12 returns to step S1201. If not (NO in step S1206), the process of FIG. 12 proceeds to step S1207.

In step S1207, the control unit 101 determines whether the select button 1315 is operated. If the select button 1315 is operated (YES in step S1207), the process of FIG. 12 proceeds to step S1208. If not (NO in step S1207), the process of FIG. 12 proceeds to step S1210.

In step S1208, the control unit 101 displays an image capturing screen 1321 on the display unit 106. FIG. 13C illustrates an example of the image capturing screen 1321. The image capturing screen 1321 displays a task icon 1323 indicating the selected task and a return button 1324 for performing an operation to return to the previous screen, in a superimposed manner on an image capturing live view 1322. By operating the release switch 105a while the image capturing screen 1321 is displayed, the user can capture an image.

In step S1209, the control unit 101 performs display for the user to confirm the image captured in step S1208. FIG. 13D illustrates an example of an image confirmation screen 1331. The image confirmation screen 1331 displays a task icon 1333 indicating the selected task, a return button 1334 for performing an operation to return to the previous screen, and an OK button 1335 for confirming a captured image 1332 for the task, in a superimposed manner on the captured image 1332. If the OK button 1335 is operated, the control unit 101 confirms the captured image 1332 for the task, and the image capturing ends.

FIG. 13E illustrates an example of a task list screen 1341 in the state where image capturing is completed for some task in the mission. The task icon corresponding to the task is replaced with a captured image 1342 confirmed by the operation on the OK button 1335.

FIG. 13F illustrates an example of a task list screen 1351 in the state where image capturing is completed for all the tasks in the mission. In this state, the digital camera 100 can submit mission data to the mobile phone 200. The task list screen 1351 displays a guidance 1352 indicating that the digital camera 100 can transmit and submit mission data to the mobile phone 200, and a submit button 1353. The submit button 1353 may be blank and unselected until the image capturing is completed for all the tasks.

In step S1210, the control unit 101 determines whether image capturing is completed for all the tasks. If image capturing is completed (YES in step S1210), the process of FIG. 12 proceeds to step S1211. If not (NO in step S1210), the process of FIG. 12 proceeds to step S1205.

In step S1211, the control unit 101 determines whether the submit button 1353 is operated. If the submit button 1353 is operated (YES in step S1211), the process of FIG. 12 proceeds to step S1212. If not (NO in step S1211), the process of FIG. 12 proceeds to step S1205.

In step S1212, the control unit 101 transmits mission data including the captured images for the respective tasks to the mobile phone 200 via the communication unit 111, and the process of FIG. 12 returns to step S1201. If the transmission of the mission data is completed, the control unit 101 displays a mission list screen 1361 illustrated in FIG. 13G. The mission list screen 1361 displays, in a pop-up manner, a guidance 1362 indicating that the mission data has been transmitted.

In step S1213, the control unit 101 determines whether another operation is performed. If another operation is performed (YES in step S1213), the process of FIG. 12 proceeds to step S1214. If not (NO in step S1213), the process of FIG. 12 proceeds to step S1215.

In step S1214, the control unit 101 performs another process.

In step S1215, the control unit 101 determines whether an end operation is performed. If the end operation is performed (YES in step S1215), the process of FIG. 12 ends. If not (NO in step S1215), the process of FIG. 12 proceeds to step S1202.

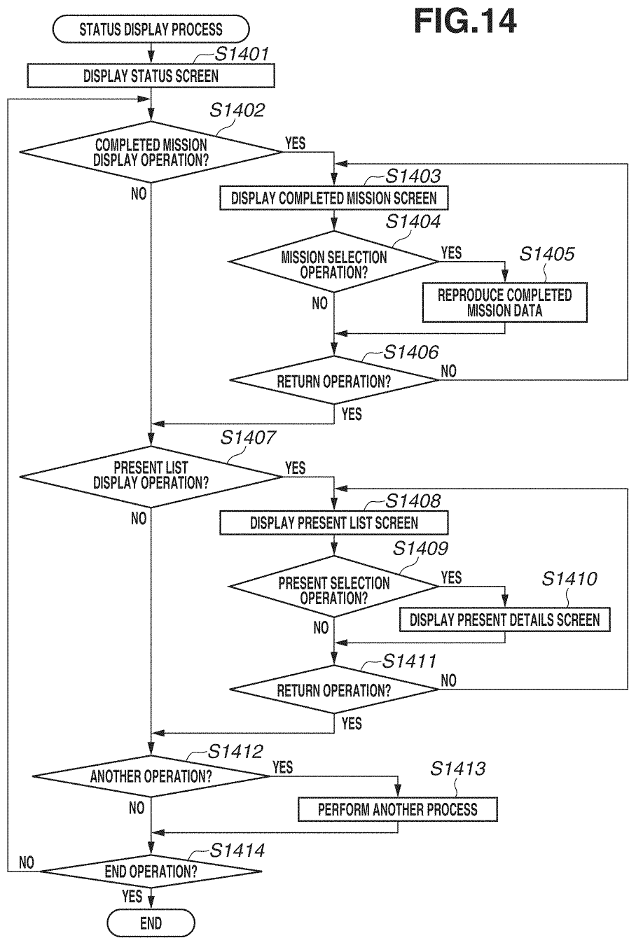

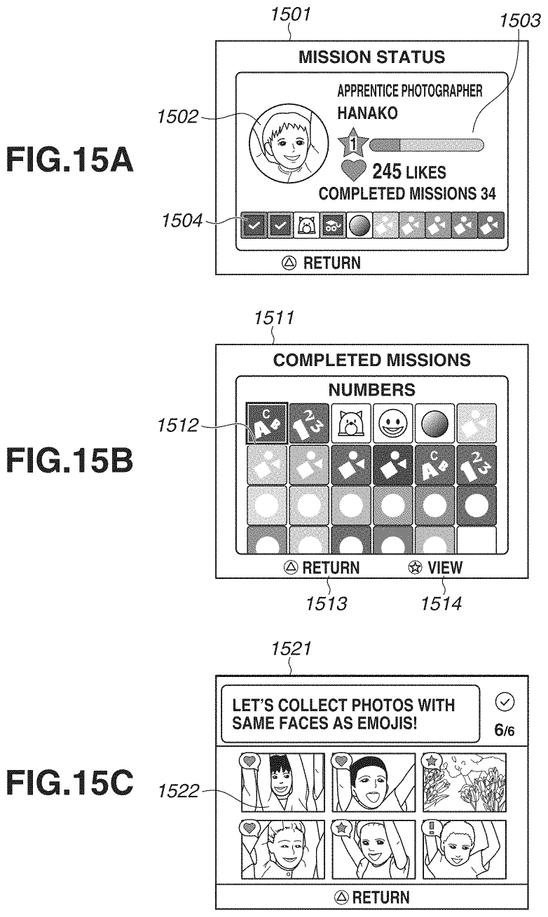

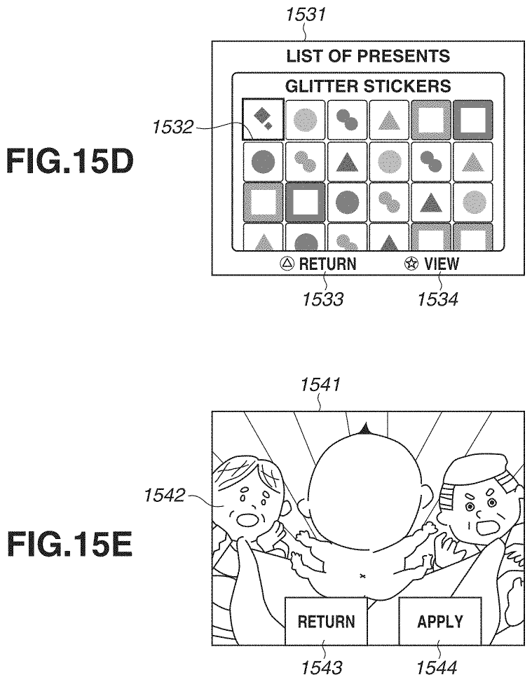

With reference to FIGS. 14 and 15A to 15E, the status display process performed by the digital camera 100 in the mission mode will be described next. FIG. 14 is a flowchart illustrating the status display process performed by the digital camera 100 in the mission mode. Each of FIGS. 15A to 15E illustrates an example of a screen displayed in the status display process by the digital camera 100 in the mission mode.

In step S1401, the control unit 101 displays on the display unit 106 a status screen 1501 indicating the status of the user of the digital camera 100. FIG. 15A illustrates an example of the status screen 1501. The status screen 1501 displays an avatar image 1502 of the user, a bar 1503 indicating the level of the user, and a mission list 1504 including missions installed on the digital camera 100. The bar 1503 extends, for example, in proportion to the progress of missions (number of accomplished missions). The number of accomplished missions can be acquired by referring to the mission completion points managed as described above. The status screen 1501 indicates, together with the avatar image 1502, that the user is an “apprentice photographer” and is at a “level 1”. The display of these information is updated based on the progress of missions.

In step S1402, the control unit 101 determines whether completed missions are selected on the status screen 1501 using the operation unit 105. If the completed missions are selected (YES in step S1402), the process of FIG. 14 proceeds to step S1403. If not (NO in step S1402), the process of FIG. 14 proceeds to step S1407.

In step S1403, the control unit 101 displays a completed mission screen 1511. FIG. 15B illustrates an example of the completed mission screen 1511. The completed mission screen 1511 displays completed missions 1512, a return button 1513 for performing an operation to return to the previous screen, and a view button 1514 for selecting, from the completed missions 1512, a mission for which captured images are to be reproduced.

In step S1404, the control unit 101 determines whether an operation corresponding to the view button 1514 is performed. If the operation is performed (YES in step S1404), the process of FIG. 14 proceeds to step S1405. If not (NO in step S1404), the process of FIG. 14 proceeds to step S1406.

In step S1405, the control unit 101 displays a completed mission data reproduction screen 1521. FIG. 15C illustrates an example of the completed mission data reproduction screen 1521. The completed mission data reproduction screen 1521 displays captured images 1522 for the respective tasks in the mission.

In step S1406, the control unit 101 determines whether an operation corresponding to the return button 1513 is performed. If the operation is performed (YES in step S1406), the process of FIG. 14 proceeds to step S1407. If not (NO in step S1406), the process of FIG. 14 proceeds to step S1403.

In step S1407, the control unit 101 determines whether an operation for displaying a list of presents, which are acquired by the user as rewards for the accomplishment of missions, is performed. If the operation is performed (YES in step S1407), the process of FIG. 14 proceeds to step S1408. If not (NO in step S1407), the process of FIG. 14 proceeds to step S1412.

In step S1408, the control unit 101 displays a present list screen 1531. FIG. 15D illustrates an example of the present list screen 1531. The present list screen 1531 displays acquired presents 1532, a return button 1533 for performing an operation to return to the previous screen, and a view button 1534 for performing an operation to view the details of a present.

In step S1409, the control unit 101 determines whether an operation corresponding to the view button 1534 is performed. If the operation is performed (YES in step S1409), the process of FIG. 14 proceeds to step S1410. If not (NO in step S1409), the process of FIG. 14 proceeds to step S1411.

In step S1410, the control unit 101 displays a present details screen 1541 on the display unit 106. FIG. 15E illustrates an example of the present details screen 1541. A present illustrated in FIG. 15E is a frame 1542 that can be recorded in a superimposed manner on a captured image. The present details screen 1541 displays a return button 1543 for performing an operation to return to the previous screen, and an apply button 1544 for performing an operation to apply the reward displayed on the present details screen 1541. The frame 1542 is an example of the present, and the present may be a sticker. Alternatively, the present may be something that extends the functionality of the digital camera 100.

In step S1411, the control unit 101 determines whether an operation corresponding to the return button 1533 is performed. If the operation is performed (YES in step S1411), the process of FIG. 14 proceeds to step S1412. If not (NO in step S1411), the process of FIG. 14 proceeds to step S1408.

In step S1412, the control unit 101 determines whether another operation is performed. If another operation is performed (YES in step S1412), the process of FIG. 14 proceeds to step S1413. If not (NO in step S1412), the process of FIG. 14 proceeds to step S1414.

In step S1413, the control unit 101 performs another process.

In step S1414, the control unit 101 determines whether an end operation is performed. If the end operation is performed (YES in step S1414), the process of FIG. 14 ends. If not (NO in step S1414), the process of FIG. 14 proceeds to step S1402.

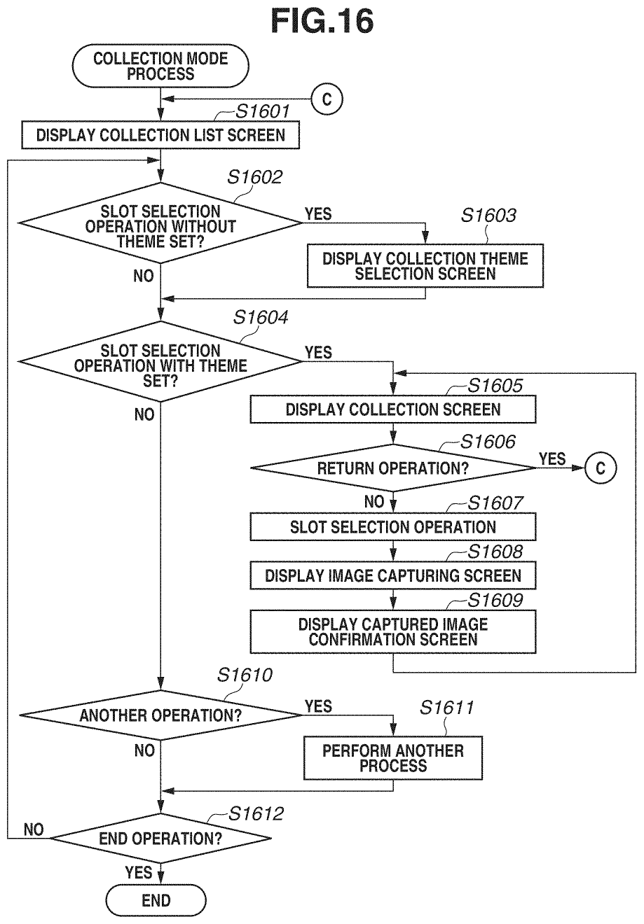

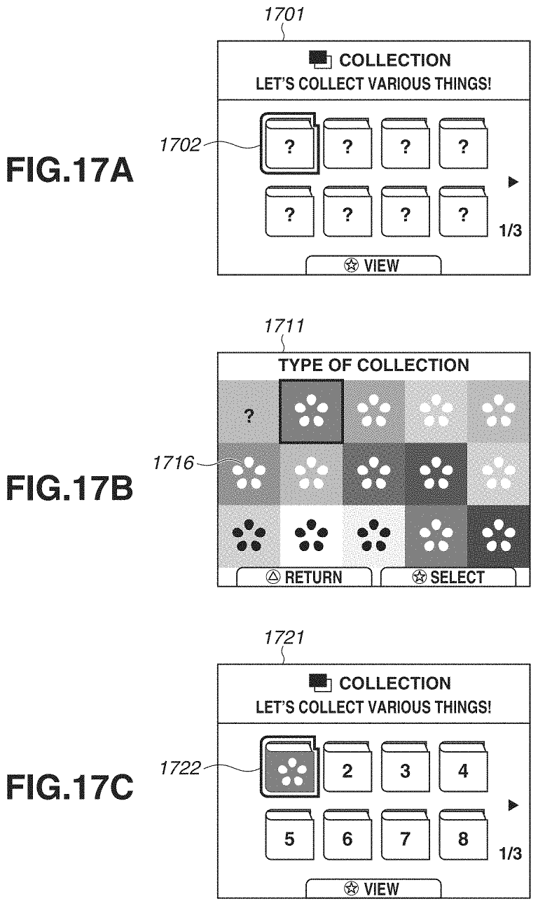

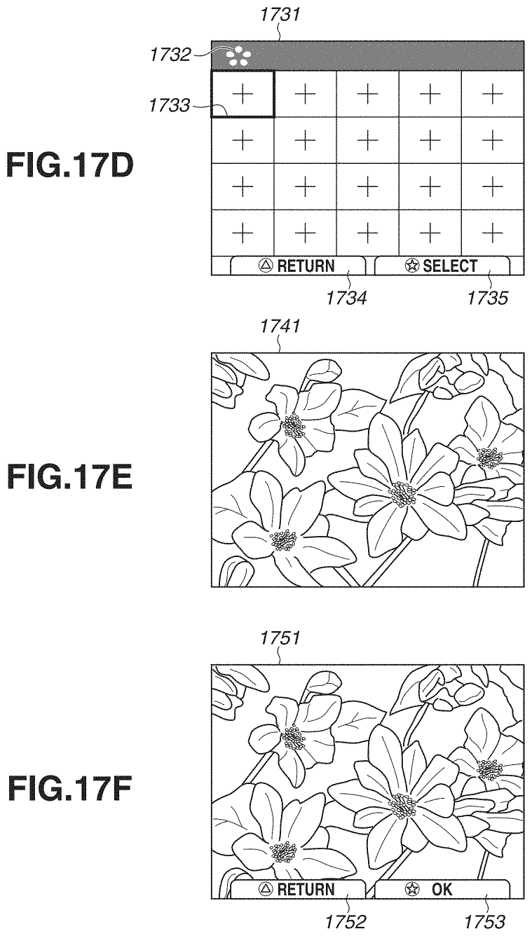

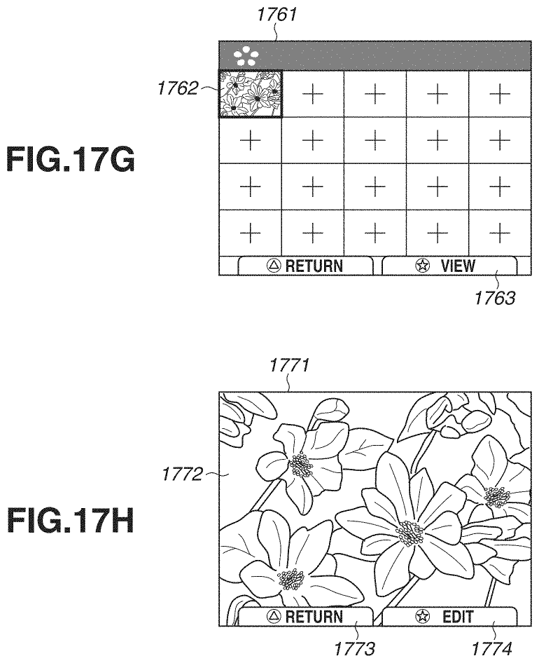

With reference to FIGS. 16 and 17A to 17H, the collection mode process performed by the digital camera 100 will be described next. FIG. 16 is a flowchart illustrating the collection mode process performed by the digital camera 100. Each of FIGS. 17A to 17H is an example of a screen displayed by the digital camera 100 in the collection mode.

In step S1601, the control unit 101 displays a collection list screen 1701 on the display unit 106. FIG. 17A illustrates an example of the collection list screen 1701. The collection list screen 1701 displays collection slots 1702 where the user can freely set themes.

In step S1602, the control unit 101 determines whether an operation for selecting a slot where a theme is not set is performed using the operation unit 105. If the operation is performed (YES in step S1602), the process of FIG. 16 proceeds to step S1603. If not (NO in step S1602), the process of FIG. 16 proceeds to step S1604.

In step S1603, the control unit 101 displays a collection theme selection screen 1711 as a screen for selecting the theme of a collection. FIG. 17B illustrates an example of the collection theme selection screen 1711. The collection theme selection screen 1711 displays icons 1716 indicating themes.

If an operation for selecting a theme is performed on the collection theme selection screen 1711, then as illustrated in FIG. 17C, a collection list screen 1721 including a slot 1722 where the theme is set is displayed.

After step S1603, the process of FIG. 16 may proceed directly to step S1605 (described below).

In step S1604, the control unit 101 determines whether an operation for selecting a slot where a theme is set is performed using the operation unit 105. If the operation is performed (YES in step S1604), the process of FIG. 16 proceeds to step S1605. If not (NO in step S1604), the process of FIG. 16 proceeds to step S1610.

In step S1605, the control unit 101 displays a collection screen 1731 on the display unit 106. FIG. 17D illustrates an example of the collection screen 1731. The collection screen 1731 displays blank slots 1733 where captured images are not present. The collection screen 1731 also displays an icon 1732 indicating the selected theme, a return button 1734 for performing an operation to return to the previous screen, and a select button 1735 for performing an operation to select a slot.

In step S1606, the control unit 101 determines whether an operation corresponding to the return button 1734 is performed. If the operation is performed (YES in step S1606), the process of FIG. 16 proceeds to step S1601. If not (NO in step S1606), the process of FIG. 16 proceeds to step S1607.

In step S1607, if an operation corresponding to the select button 1735 is performed, the process of FIG. 16 proceeds to step S1608.

In step S1608, the control unit 101 displays an image capturing screen 1741 on the display unit 106. FIG. 17E illustrates an example of the image capturing screen 1741. By operating the release switch 105a while the image capturing screen 1741 is displayed, the user can capture an image.

In step S1609, the control unit 101 performs display for the user to confirm the captured image. FIG. 17F illustrates an example of a captured image confirmation screen 1751. The captured image confirmation screen 1751 displays a return button 1752 for performing an operation to return to the previous screen, and an OK button 1753 for performing an operation to end the image capturing.

In step S1610, the control unit 101 determines whether another operation is performed. If the operation is performed (YES in step S1610), the process of FIG. 16 proceeds to step S1611. If not (NO in step S1610), the process of FIG. 16 proceeds to step S1612.

FIG. 17G illustrates an example of a collection screen 1761 where the captured image is added to a slot. The collection screen 1761 displays an added image 1762 and a view button 1763 for performing an operation to reproduce the image.

If the view button 1763 is operated in the state where the collection screen 1761 is displayed, the control unit 101 displays a view screen 1771 illustrated in FIG. 17H on the display unit 106. The view screen 1771 displays, together with a captured image 1772, a return button 1773 for performing an operation to return to the previous screen, and an edit button 1774 for performing an editing operation on the captured image 1772. By operating the edit button 1774, the user can apply a frame obtained as a present to the captured image 1772, or perform image capturing again to replace the captured image 1772.

In step S1611, the control unit 101 performs another process.

In step S1612, the control unit 101 determines whether an end operation is performed. If the end operation is performed (YES in step S1612), the process of FIG. 16 ends. If not (NO in step S1612), the process of FIG. 16 proceeds to step S1602.

While the description has been given by using the example where the digital camera 100 and the mobile phone 200 are connected to each other through wireless communication, the digital camera 100 and the mobile phone 200 may be connected to each other through wired communication. Alternatively, the digital camera 100 and the mobile phone 200 may be connected to each other via another communication apparatus or another communication network.

The control unit 101 of the digital camera 100 may be implemented by a single hardware, or may be implemented by a plurality of hardware sharing processes. The control unit 201 of the mobile phone 200 may also be implemented by a single hardware, or may also be implemented by a plurality of hardware sharing processes.

### Other Exemplary Embodiments

Exemplary embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, or the like.

While aspects of the disclosure are described with reference to exemplary embodiments, it is to be understood that the aspects of the disclosure are not limited to the exemplary embodiments. The scope of the following claims is to be accorded the broadest interpretation so as to encompass all such modifications and equivalent structures.

This application claims the benefit of Japanese Patent Application No. 2020-028055, filed Feb. 21, 2020, which is hereby incorporated by reference herein in its entirety.

What is claimed is:

1. An imaging apparatus comprising:
an image capture unit;
a management unit configured to manage a mission regarding image capturing;
a communication unit configured to transmit an image captured based on the mission to an external apparatus and receive an evaluation of the transmitted image; and
a display unit configured to perform a display indicating progress of the mission managed by the management unit, based on the received evaluation.

2. The imaging apparatus according to claim 1, wherein the display unit displays a status screen including an avatar that represents a user of the imaging apparatus, and updates the status screen based on the progress of the mission.

3. The imaging apparatus according to claim 2, wherein the display unit displays, on the status screen, a level of the user based on the progress of the mission.

4. The imaging apparatus according to claim 2, wherein the display unit displays the status screen based on setting information regarding the avatar, the setting information being acquired from the external apparatus after a pairing process is performed with the external apparatus via the communication unit.

5. The imaging apparatus according to claim 1, wherein the display unit displays a list of missions evaluated as completed by the external apparatus, and in a case where a mission is selected from the list, the display unit displays an image captured for the selected mission.

6. The imaging apparatus according to claim 1, wherein the mission includes tasks, and
wherein the display unit displays an evaluation for each of the tasks.

7. The imaging apparatus according to claim 1, wherein the management unit receives the mission from the external apparatus via the communication unit and adds the mission.

8. The imaging apparatus according to claim 1, wherein the imaging apparatus is a camera.

9. A method comprising:
managing a mission regarding image capturing;
transmitting an image captured based on the mission to an external apparatus;
receiving an evaluation of the transmitted image; and
performing a display indicating progress of the managed mission, based on the received evaluation.

10. A non-transitory storage medium that stores a program causing a computer to execute a method, the method comprising:
managing a mission regarding image capturing;
transmitting an image captured based on the mission to an external apparatus;
receiving an evaluation of the transmitted image; and
performing a display indicating progress of the managed mission, based on the received evaluation.
